(19) United States
(12) Patent Application Publication
(10) Pub. No.: US 2025/0206316 A1
(43) Pub. Date: Jun. 26, 2025

(54) NEURAL NETWORK AUDIO PROCESSING TO DETERMINE WEATHER CHARACTERISTICS

(71) Applicant: Zoox, Inc., Foster City, CA (US)

(72) Inventors: Xuan ZHONG, San Jose, CA (US); Derek Xiang MA, San Carlos, CA (US); Nehemia Girma TEREFE, Foster City, CA (US); Hang REN, Westbury, NY (US); Shaminda SUBASINGHA, San Ramon, CA (US); David Donald LOGAN, Morgan Hill, CA (US)

(21) Appl. No.: 18/392,371

(22) Filed: Dec. 21, 2023

(51) Int. Cl. B60W 40/02; B60W 60/00; G06N 3/08

(52) U.S. Cl. CPC B60W 40/02; B60W 60/0018; G06N 3/08; B60W 2420/54; B60W 2555/20

(57) ABSTRACT

A method includes receiving an audio signal from an audio sensor of a vehicle, determining an audio feature based at least in part on the received audio signal, using a neural network to process the determined audio feature to estimate a characteristic of weather in an environment of the vehicle, and modifying a parameter of the vehicle based at least in part on the estimated characteristic.

### BACKGROUND

Vehicles, and especially road-going vehicles, are designed to operate in a range of weather conditions. Users may expect to be able to travel in windy conditions, during a rainstorm, or in the presence of snow or sleet. Rain may change how a vehicle handles on the road, as well as potentially obscuring the vision of a user and/or affecting an ability of sensors of the vehicle to accurately take readings. In the context of an autonomous vehicle, the weather conditions may be factors in which software modules are used for perception, planning and prediction, and/or may affect values of parameters for controlling those modules.

### BRIEF DESCRIPTION OF DRAWINGS

The detailed description is described with reference to the accompanying figures. The use of the same reference numbers in different figures indicates similar or identical components or features.

FIG. 1 schematically depicts a scenario in which an operational design domain (ODD) for a vehicle is calculated using a method according to the present disclosure.

FIGS. 2A and 2B depict features of an exterior microphone.

FIGS. 3A and 3B depict sections of the exterior microphone of FIGS. 2A and 2B.

FIGS. 4A, 4B and 4C respectively show a waveform representing an audio signal and outputs of neural networks used to process a spectrogram representation of the audio signal.

FIGS. 5A and 5B depict outputs of two neural networks processing spectrogram representations of two different audio signals.

FIG. 6 depicts a flow chart of a process for modifying a parameter of a vehicle according to examples.

FIG. 7 depicts a flow chart of a process for obtaining a fine-tuned neural network according to examples.

FIG. 8 is a block diagram illustrating an example vehicle system.

### DETAILED DESCRIPTION

It is useful for a vehicle, such as an autonomous vehicle, to be able to operate in a wide range of operating conditions. For an autonomous vehicle, a set of operating conditions may correspond to a given operational design domain (ODD) in which the vehicle is designed to operate. The autonomous vehicle may have different operating modes for the different ODDs. An ODD may be defined in terms of various factors including, for example, physical infrastructure, operational constraints, objects, connectivity, environmental conditions, and/or zones. Physical infrastructure may include roadway types, surfaces, edges, and geometry. Operational constraints may include speed limits and traffic conditions. Environmental conditions may include weather, illumination, and similar sub-categories. Zones may include regions, states, school areas, construction sites and similar. An important factor for defining an ODD can be weather conditions, for example whether precipitation such as rainfall is present and if so the rate and type of precipitation, as well as other factors such as wind speed, fog, and air temperature. This application relates to techniques including methods, systems, and computer-readable media for characterizing weather effects within an environment. The techniques make use of one or more audio sensors of the vehicle for capturing audio signals which can then be used to determine weather conditions associated with an environment, for example detecting and/or quantifying rainfall. The techniques described herein may also be applied to detect other precipitation or other material. For example, the techniques may be applied to detect falling snow, hail, or sleet, and/or to detect dust, sand, or other precipitate or particulate matter that may be present in an environment through which the vehicle is travelling, such as insects. Collectively, rain, other precipitation, and other material may be referred to as environmental or atmospheric material. Aside from detecting and quantifying atmospheric material, the techniques may additionally, or alternatively, be used to determine characteristics such as wind speed and/or wetness of a road.

Understanding when it is raining, how long it has been raining for, and, where possible, the intensity of the rainfall, may be useful for determining how a vehicle may handle while travelling across a surface, such as a road. Vehicle handling may differ between different surface types, and such handling may be affected by the surface being wet to different extents. For example, light rain may cause only a small change in handling on asphalt as it becomes damp and therefore may cause only a slight change in, e.g., braking distances, whereas heavy rain may cause water to pool on the surface, which may significantly change how the vehicle handles. Similarly, different durations of rain may affect the handling and operation of the vehicle by causing different amounts of water to accumulate on a surface. Rainfall or other precipitation may also affect the performance of various sensors used by a vehicle for the purpose of autonomous driving. An understanding of the rainfall may therefore be used to determine whether and how often such sensors require cleaning to continue to operate effectively, and to implement suitable cleaning techniques.

In vehicles having a human operator, such as manual or semi-autonomous vehicles, understanding the rain may be useful to provide some automatic function to assist the operator, such as automatically operating wipers to clear a windshield. In autonomous vehicles, without a human operator, understanding rainfall may be critical to allowing the vehicle to continue operation, by adjusting its systems to account for the rainfall. For example, different hardware or software modules for tasks such as prediction, planning, or perception of the environment, may be activated, or parameter values of such modules may be modified, in different precipitation conditions. The weather information may also be used to turn machine-learned models, apply certain filters, and/or be used as a determination that a vehicle can or cannot operate within the environment (in real time).

In some examples, vehicles may incorporate ‘rain sensors’. Rain sensors may utilize reflections of infrared light to determine when water or another liquid is present on a windshield of the vehicle. Such sensors may therefore be used to determine whether liquid or debris is present on a windshield. However, such sensors are typically only useful for detecting liquids or debris on transparent surfaces, and may be unable to accurately differentiate between ongoing rainfall and other liquids on the surface, such as caused by splashes from puddles, limiting their usefulness in the context of autonomous driving. Moreover, rain sensors may require precise and widespread placement to be usable in such applications, which may not be feasible within an autonomous vehicle. Additionally, autonomous vehicles may not use a windshield and therefore may have sufficient window surface area to make such sensors viable or useful. Various other types of sensors, such as image sensors, may also be used or adapted for detecting rainfall, but use of such sensors typically results in low accuracy and/or robustness, particularly in variable visibility conditions such as different light levels. Some of the shortcomings described above may be partially alleviated by supplementing data generated by sensors with local weather report data obtained via wireless communication means, but such data may also be insufficient due to lacking the required level of accuracy or geographic/temporal localization, as well as potentially introducing an unacceptable degree of latency.

The techniques described herein provide one or more sensors that enable rainfall on or close to a vehicle to be determined in real time, and which may enable the rainfall to be categorized and/or quantified. To make such determinations, the techniques can utilize one or more audio sensors, which may include electromechanical transducers arranged to generate electrical signals in dependence on vibrations or acoustic waves in the vicinity of the electromechanical transducers. The audio sensors may for example include one or more microphones that may be disposed on an exterior of a vehicle or otherwise provided with a conduit or channel providing fluid communication between the audio sensor(s) and the outside environment. Alternatively, or additionally, the audio sensors may include one or more accelerometers affixed to a suitable surface or panel of the vehicle, for example affixed to an inside surface of an exterior body panel of the vehicle. Such sensors may also be used for one or more other purposes. For example, a vehicle may incorporate one or more microphones configured to detect audio signals corresponding to sirens from emergency vehicles, so that the vehicle may be operated to give way to the emergency vehicle. In some examples, one or more audio sensors of a vehicle may be configured to detect audio signals that indicate impacts on a body of the vehicle. As a result of utilizing the same sensors for rainfall detection, efficient use is made of the sensors, and the need to incorporate new, specific sensors for rain detection may be avoided. As noted above, while a vehicle may additionally include other sensors such as image sensors or cameras for use in autonomous driving, use of such sensors for rain detection has proven less accurate and less robust than methods according to the present disclosure. Although the techniques herein refer to audio sensors provided on a vehicle, the techniques are applicable to determining rainfall using audio sensors mounted to other structures or objects.

Rainfall may be detected based on properties of an audio sensor and the assembly or unit in which it is provided. For example, a microphone unit may comprise a housing and one or more protective elements such as a protective mesh delimiting an air-filled cavity that exhibits a resonance associated with air moving in and out of the cavity. Sound from an environment in which the vehicle is travelling may excite the resonance and this may be picked up by the microphone. The frequency of the resonance, as picked up by the microphone, may show a higher amplitude than other frequencies, when frequency analysis is performed. The presence of water and the amount of water in contact with the microphone unit may cause a different resonance frequency compared to when the microphone unit is dry, which may result from the water plugging perforations in the protective mesh and therefore changing the dynamics of air moving in and out of the cavity and its associated natural frequency. In addition, raindrops hitting the microphone unit may change the amount of water in contact with the microphone, meaning that how often the resonance frequency changes and/or the amount by which the frequency changes may also be analyzed to quantify or categorize rainfall. Yet further, those raindrops may also create noise and/or excite the resonance of the microphone unit when they strike the microphone unit or a part of the vehicle in a vicinity of the microphone unit, enabling detection of individual droplets striking the microphone unit. Individually, or together, each of these different indicators may be used to determine characteristics of rainfall in the vicinity of the vehicle, such as when rain is falling close to or on the microphone unit, how hard the rain is falling, and/or the absolute or relative direction of the rain. Techniques for determining characteristics of rainfall using heuristic methods based on these observations can be found, for example, in U.S. application Ser. No. 18/470,676, filed Sep. 20, 2023, and titled “Rain Detection Using Exterior Microphones”, the entire contents of which are incorporated herein by reference in their entirety and for all purposes.

The present application provides alternative techniques for determining characteristics associated with an environment of a vehicle, for example characteristics associated with weather conditions or other driving conditions. The present disclosure provides a method including receiving an audio signal from an audio sensor of a vehicle, determining an audio feature from the received audio signal, using a neural network to process the audio feature to estimate a characteristic of weather in an environment of the vehicle, and modifying a parameter of the vehicle based at least in part on the estimated characteristic.

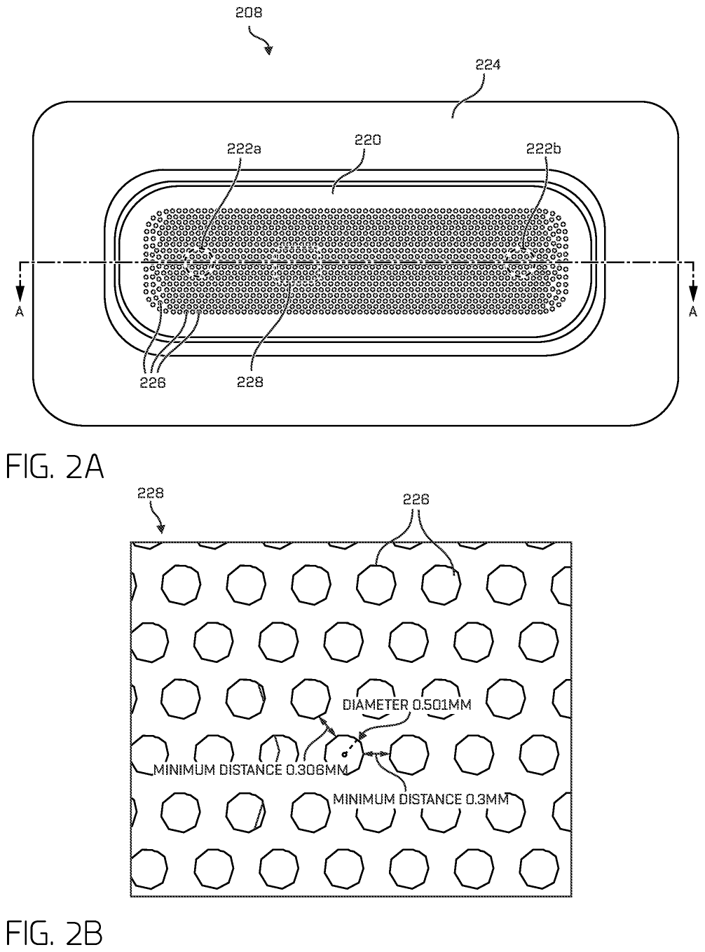

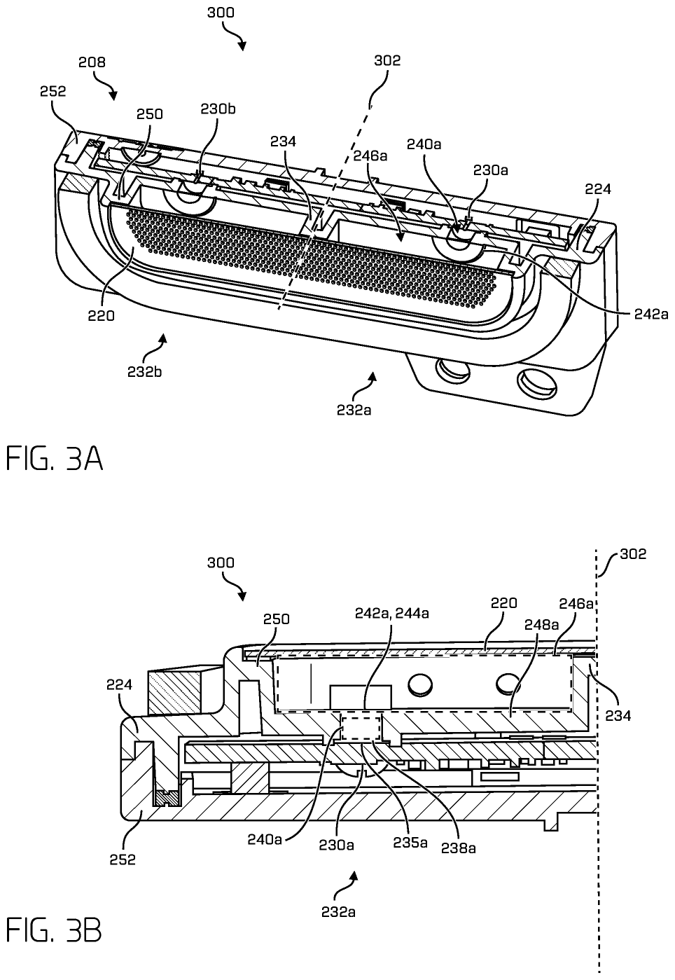

The audio sensor may be an electromechanical transducer capable of converting vibrational energy such as sound waves or other mechanical waves into an electrical signal referred to as an audio signal. The audio sensor may for example be a microphone disposed on an outer surface of the vehicle such as the microphone described hereinafter with reference to FIGS. 2A, 2B, 3A and 3B. Alternatively, the audio sensor may include an accelerometer attached to a suitable surface of the vehicle, such as on an underside of a roof panel of the vehicle or on an inner surface of a front panel, side panel, door panel, or any other metal panel or other panel capable of reverberating when struck by a raindrop or other precipitation.

The audio signal generated by the audio sensor may be converted, transformed, or otherwise processed to determine or extract suitable audio feature(s) for processing by the neural network. The audio feature(s) may comprise data that is derived from the audio signal and may encapsulate aspects of the audio signal that a neural network can learn to use to discriminate between different characteristics, such as different weather characteristics. For example, the audio signal may be transformed into a spectrogram or sonograph, such as a log-mel frequency spectrogram. The spectrogram may be an audio feature which is a visual representation of the spectrum of frequencies of the audio signal as it varies with time, for example exhibited as a heatmap indicating intensities in a two-dimensional plane with a horizontal temporal axis and a vertical frequency axis. The spectrogram may be generated for example by applying a short-time Fourier transform (STFT) or any other suitable transformation to the audio signal. The procedure for applying the STFT to the audio signal may include dividing the audio signal into relatively short segments (frames) of equal length and then computing the Fourier transform separately on each segment. This may reveal the Fourier spectrum on each segment, which may be interpreted as a spectrogram or sonograph of the audio signal. The spectrogram may have a format corresponding to that of a digital image (or a sequence of digital images) and may therefore be suitable for processing by a neural network configured for image processing, such as a convolutional neural network (CNN), a recurrent neural network (R-CNN), a vision transformer (ViT) or any other neural network architecture suitable for processing image data. The neural network may be a classification network or a regression network and may be configured to estimate a characteristic associated with the environment based on processing at least part of the spectrogram of the audio signal.

Other audio features may be provided as an input to the neural network alongside, or instead of, a spectrogram representation. Examples of audio features may include a waveform or other time-domain representation of the audio signal, features derived from time-domain filterbanks, mel frequency cepstral coefficients (e.g., derived from mel filterbanks), mel frequency cepstral differential features, tempograms, spectral features, or learned features such as LeAF as described in the article Learnable Frontend for Audio Classification, Neil Zeghidour et al, ICLR 2021, the contents of which are incorporated by reference in their entirety for all purposes.

The characteristic of weather in the environment of the vehicle may be a characteristic of precipitation in a vicinity of the vehicle. The characteristic may include, for example, a value for a parameter associated with the precipitation. The parameter may be a droplet size, an intensity of the precipitation, a rate of precipitation, a number of precipitation events, a direction of precipitation, or a type of precipitation, for example rain, snow, or sleet. The intensity of the precipitation may be measured as a number of precipitation events per second per unit of area. The intensity may be determined based on a number of impacts per second observed across a known area, such as an area of a shield or element for protecting the audio sensor from environmental material. The characteristic may include a category of a set of categories associated with different levels of precipitation. For example, the set of categories may include light, medium, and heavy precipitation. In other examples, the characteristic may include a wind speed and/or wind direction, or an indication of whether the driving surface is wet (and optionally the extent of any wetness).

The characteristic of weather in the environment may for example be a number of precipitation events detected within a given interval, where each precipitation event corresponds to a raindrop striking a surface in a vicinity of the audio sensor. In such cases, the characteristic may be associated with an effective rainfall rate. The effective rain rate may be described as an intensity of rain drops striking a surface of the vehicle, whether moving or stationary. The effective rainfall rate may be different for audio sensors disposed at different positions on the vehicle and may be proportional to a rate of rain drops striking a surface in a vicinity of a given audio sensor. The effective rain rate may depend on the speed and/or direction of travel of the vehicle, and accordingly, the vehicle's speed and/or direction of travel (in other words, the vehicle's velocity) may also be taken into account when determining the characteristic. More generally, the relationship between absolute precipitation characteristics (as experienced by a stationary observer) and the effective rain characteristics may be dependent on the velocity of the vehicle, and therefore velocity of the vehicle may be used as an additional signal for determining the precipitation characteristics.

In some examples, the velocity (or one or more components of the velocity) of the vehicle may be provided as an additional input to the neural network used to process the audio feature. In examples, the velocity may be combined with a characteristic estimated by the neural network. For example, the neural network may be used to determine an effective precipitation characteristic, which may be combined with the velocity to determine an absolute precipitation characteristic for use in determining the ODD of the vehicle. For example, the neural network may be used to determine a number N of raindrops striking a forward-facing surface of area A within an interval of duration t. Assuming an absolute rain rate of x, and that the raindrops fall vertically with terminal velocity Vr and the vehicle moves at speed Vc, the volume swept out by the surface within the interval may be given by Vc*t*A. The cumulative volume of the raindrops striking the surface is then given by Vc*t*A*x/Vr. Assuming that the number of detected raindrops for a given volume of rainfall on the surface is given by a, the number of raindrops N is given by N=a*Vc*t*A*x/Vr, or the rain rate is given by x=N*Vr/(a*Vc*t*A). The number N of detected raindrops may be determined by the neural network. The vehicle speed Vc may be determined from a vehicle speedometer, or by GPS, or by any other suitable method. The number of detected raindrops a for a given volume may be estimated based on a rainfall size distribution (such as the Marchall-Palmer distribution) and an empirical measurement of the minimum size of raindrop necessary to cause a detectable event. In this way, a number of rainfall events detected by the neural network within an interval in which the vehicle is travelling at a known (e.g., average) speed can be converted to an absolute rainfall rate. It will be appreciated that the preceding calculations can be generalized and may be modified, for example, if the surface in the vicinity of the audio sensor is an upward-facing or any other non-forward-facing surface, or in the event that rain is not falling vertically. Certain values used in the calculations may be variable and this may be accounted for in the calculations. For example, the terminal velocity Vr, may depend on the type of precipitation and the atmospheric pressure, which may in turn depend on factors such as temperature and altitude.

The vehicle may be provided with multiple audio sensors. The audio sensors may be positioned on either or both ends of the vehicle, such as a front or a rear end. The vehicle may be a bi-directional vehicle, such that each end may act as the front or the rear end. Alternatively, or additionally, one or more audio sensors may be positioned on either or both sides of the vehicle and/or on top of the vehicle. By combining estimates from multiple audio sensors, improved accuracy or confidence in the estimated characteristics may be achieved, and furthermore additional characteristics or information may be determined. For example, the audio sensor may be a first audio sensor and the method may include receiving a second audio signal from a second audio sensor disposed on the vehicle. The second audio sensor may be separate from the first audio sensor. The second audio sensor may be oriented differently to the first audio sensor. For example, the first audio sensor may be provided on an end of the vehicle and the second audio sensor may be provided on a side of the vehicle, or each of the first and second audio sensors may be provided on different ends or sides of the vehicle.

The method may further comprise processing the first audio signal and the second audio signal to determine an absolute or effective direction of the precipitation (such as rainfall), and/or an absolute or effective horizontal velocity of the precipitation. The direction and/or horizontal velocity of the precipitation may be determined based on differences between the first audio signal and the second audio signal. For example, one audio signal having a higher rate of precipitation events than the other may indicate that the rain is falling towards the audio sensor associated with the higher rate. In examples, audio signals from further audio sensors may also be used. Determining a direction or horizontal velocity of rainfall may be used to more accurately determine absolute rainfall rates, for example by adjusting the calculations described above to account for the relative velocity between the raindrops and the audio sensor. Alternatively, by providing audio features derived from multiple audio sensors as inputs to the neural network, absolute rainfall characteristics such as absolute rain rate may be estimated as direct outputs of the neural network.

In addition to determining direction, differences between audio signals from different audio sensors may be averaged and/or checked for consistency to determine a confidence in the estimated characteristic. For example, if the first audio sensor consistently measures a lower precipitation rate than the second audio sensor, this may suggest a calibration error or a physical obstruction such as dirt on the first audio sensor. Various actions may then be carried out, such as a cleaning operation and/or discarding measurements from the first audio sensor until the first and second audio sensors provide consistent results.

Other data may be provided as inputs to the neural network alongside the audio feature(s) derived from the audio signal. For example, environmental conditions may have an effect on the audio signal, for example by contributing to changes in background noise or changes to relevant audio features such as those corresponding to precipitation events. Therefore, allowing the neural network to account for such conditions may enable the neural network to determine more accurate estimates of a characteristic of the weather, such as precipitation. Examples of environmental conditions that may be provided include air temperature, air pressure, altitude, humidity, and/or classification of environment type (e.g., urban or highway).

Other examples of environmental characteristics include absolute or relative wind speed and/or wind direction (collectively, wind velocity), which may affect background noise as well as precipitation direction. Wind velocity may be determined in real-time using sensors, for example an anemometer located on the vehicle or elsewhere in the environment. In examples, wind velocity may be estimated using audio signals, which may optionally be the same audio signals used to estimate the weather characteristic of interest. For example, audio signals from multiple audio sensors facing in different directions may be processed individually to estimate wind speeds in those different directions. Alternatively, audio signals from multiple audio sensors facing in different directions may be processed together to estimate wind velocity directly. The processing may be performed using one or more auxiliary neural networks, or auxiliary neural network heads, trained to estimate wind speeds or wind velocities, or any other suitable regression model. The estimated wind velocity may be provided as an input to the main neural network to enable more accurate determination of precipitation characteristics. Nevertheless, in other examples the wind velocity may not be estimated explicitly, but the neural network may be trained to estimate weather characteristics based on audio signals from multiple audio sensors, and may therefore learn to use differences between audio signals from different audio sensors to estimate an absolute precipitation characteristic. Furthermore, the relative or absolute wind velocity may be used to determine absolute precipitation characteristics from relative precipitation characteristics estimates, for example where the latter is estimated by the neural network.

Of course, utilizing the audio sensor(s) for estimating weather characteristics may not preclude the audio sensor(s) from being used for other functions. The method may for example also include processing the audio signal to detect a siren in a vicinity of the vehicle.

Once the characteristic of the weather has been determined, it may be used to adapt how the vehicle is operated. The method may include controlling the vehicle and/or one or more components of the vehicle in accordance with the modified parameter of the vehicle. The vehicle may for example be controlled to switch from a first mode of operation for operating the vehicle in dry conditions to a second mode of operation for operating the vehicle in wet conditions. The second mode of operation may for example cause the vehicle to drive more slowly, leave a greater gap to vehicles ahead, or implement other modified driving operations characteristic of more cautious driving due to a greater expected stopping distance. The extent of modification of the driving operations may depend on the estimated characteristic of the environment, such as the estimated rainfall rate.

In examples, the parameter of the vehicle may be used to control switching between different hardware or software modules, or different models, for tasks such as prediction, planning, or perception of the environment. Alternatively, the parameter may be an operating parameter of one of such modules/models, or an operating parameter of a control system of the vehicle. For example, different thresholds or constraints for vehicle dynamics may be used for weather conditions that are associated with reduced visibility (or less accurate sensor performance) and/or reduced traction. In the latter case, a parameter of the traction control system may be modified to mitigate the effect of increased stopping distance.

In an example, the method may include determining, based at least in part on the estimated characteristic (optionally along with other information, e.g., derived from other sensors on the vehicle, stored locally by the vehicle, or received from a remote system) that the environment is outside of an approved ODD for the vehicle (or, alternatively, out of any approved ODD for the vehicle). In this case, modifying the parameter may cause the vehicle to operate differently in order to avoid reduced safety of the passengers and other road users. For example, the vehicle may avoid certain maneuvers (such as unprotected right turns) due to insufficient confidence in perception. In some examples, the modifying of the parameter may cause the vehicle to suspend full autonomous driving operation. For example, the vehicle may pull over at a next safe location and refrain from further autonomous driving until the environment is determined to be inside an approved ODD. Additionally, or alternatively, the vehicle may contact a teleoperations team to inform them and potentially other vehicles that the environment is outside of the approved ODD, and/or to request remote oversight or full/partial remote control the vehicle based on video data streamed from the vehicle. In examples, the vehicle's collision avoidance system may determine that certain trajectories generated by the planning component or module are no-go trajectories in the event of the environment being outside an approved ODD.

The method may also include performing one or more actions based on the estimated characteristic. For example, the method may include initiating sensor cleaning or activate windshield wipers upon determining that a rainfall characteristic exceeds a given threshold. Furthermore, a message may be sent to one or more remote computing systems to indicate that the characteristic has been estimated. The message may identify a map location associated with the characteristic. The remote computing system may be configured to communicate the characteristic and/or other information based on the characteristic to one or more other vehicles. The remote computing system may update a shared map based on the received map location data and the characteristic.

According to a further aspect, there may be provided one or more non-transitory computer-readable media. The one or more non-transitory computer-readable media stores instructions executable by one or more processors, wherein the instructions, when executed, cause the one or more processors to perform operations comprising a method as described above. According to a further aspect, there may be provided a vehicle comprising a microphone, one or more processors, and one or more non-transitory computer-readable media storing instructions which, when executed by the one or more processors, cause the one or more processors to perform operations comprising a method as described above.

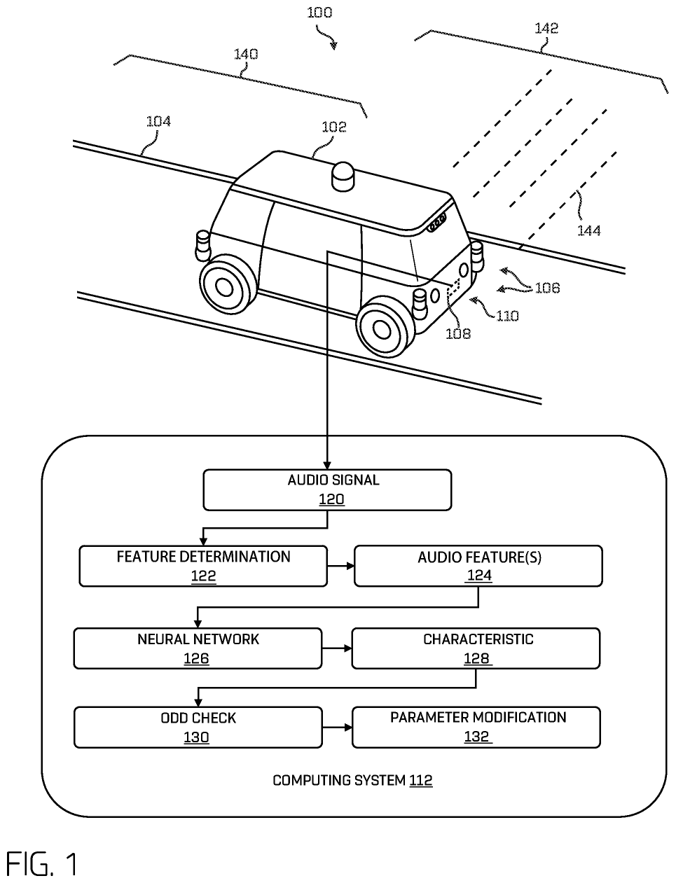

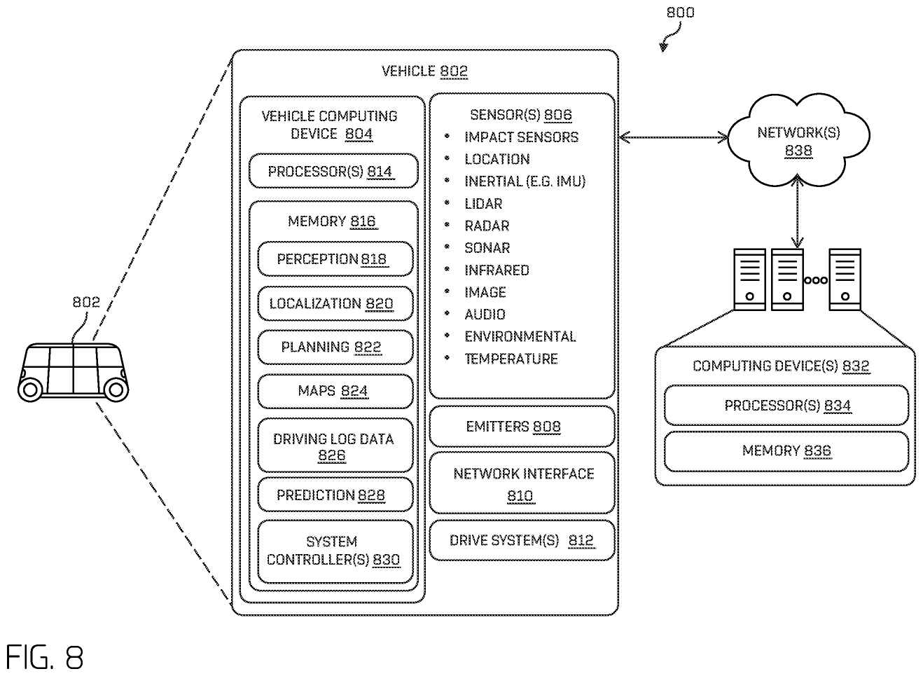

Turning now to the figures, FIG. 1 illustrates a scenario 100 in which a vehicle 102 is travelling along a road 104. The vehicle 102 may include a plurality of sensors 106. The plurality of sensors 106 may include a microphone unit 108. The microphone unit 108 may be mounted on the vehicle 102 at an end 110. Although not shown in FIG. 1, one or more further microphone units may be provided on the vehicle 102. Further microphone units may be mounted to other exterior surfaces of the vehicle 102, such as another end or a side of the vehicle. The microphone unit 108, as will be described in more detail in relation to FIGS. 2A-3B below, may include at least one microphone, a protective element, and a housing (not shown in FIG. 1). The vehicle 102 also comprises a computing system 112. An example of a computing system 112 is described below in relation to FIG. 8. The computing system 112 may comprise one or more processors (not shown) for performing computations. Although the computing system 112 in the present example is a component of the vehicle 102, it will be appreciated that in other examples, operations performed by the computing system 112 may be performed by a device or system remote from the vehicle 102.

FIG. 2A shows a front view of a microphone unit 208. The microphone unit 208 may be mounted on a vehicle, such as vehicle 102, and used as described above in relation to microphone unit 108. FIG. 2A illustrates a protective element 220 of the microphone unit 208. The protective element 220 may cover one or more microphones of the microphone unit 208, and in the example of FIG. 2A, the microphone unit 208 includes two microphones. The positions of the two microphones are indicated in FIG. 2A as position 222a of a first microphone and position 222b of a second microphone, as the microphones themselves are obscured by the protective element 220. The microphone unit 208 may also include a housing 224 that holds the protective element 220 in a position to protect the microphones.

The protective element 220 may be arranged to allow sound to pass through it or around it. The protective element may comprise a plurality of perforations 226 and may comprise a mesh or grill. FIG. 2B illustrates a portion 228 of the protective element 220 that has been enlarged so that the perforations 226 and the distances between them can be identified. As illustrated in FIG. 2B, the perforations 226 have a uniform diameter of approximately 0.5 mm and are arranged on a hexagonal lattice with a spacing such that any two perforations 226 are separated by a minimum distance of 0.3 mm. Perforations 226 of this size may allow sound to travel through the protective element 220 to reach the one or more microphones of the microphone unit 208 whilst also preventing any substantial ingress of water or other debris or environmental material. It will be appreciated that other arrangements and/or dimensions of perforations, or other types of protective element, may be used.

FIG. 3A shows a perspective view of a cross section 300 of the microphone unit 208 along the line A-A (shown in FIG. 2A). FIG. 3B shows a plan view of one half of the cross section 300 of the microphone unit 208. The half of the cross section 300 shown in FIG. 3B is the half of the microphone unit 208 to the right of line 302. The microphone unit 208 has mirror symmetry about the line 302, so only one half of the microphone unit 208 is described in relation to FIG. 3B for clarity. The description in relation to FIG. 3B below may equally be applied to the other half of the microphone unit 208.

The microphone unit 208 may comprise a first microphone 230a and a second microphone 230b. The microphones 230a, 230b may be MEMS microphones. In examples, the microphones 230a, 230b may be a different type of microphone. The microphones 230a, 230b may be piezoelectric microphones, condenser microphones, dynamic microphones, or any other type of microphones.

Each microphone 230a, 230b may be provided in a respective portion 232a, 232b of the microphone unit 208. The portions are separated by a central support 234 of the housing 224. Only one portion 232a is shown in FIG. 3B.

Considering the portion 232a shown in FIG. 3B, the microphone 230a may be provided at least partially within an aperture 236a of the housing 224. The aperture 236a may be fluidly connected to a first end 238a of a first cavity 240a, which may be cylindrical in shape, delimited by the housing 224. A vent 242a may at least partially cover a second end 244a of the first cavity 240, which may be opposite the first end 238a. The vent 242a may be covered by a hydrophobic weave or other suitable material that allows air to pass through the vent 242a but prevents liquid from passing through the vent 242a to reach the microphone 230a. The first cavity 240 may be fluidly connected at its second end 244a to a second cavity 246a that is delimited by the housing 224 and the protective element 220. The second cavity 246a may be delimited by a recessed portion 248a of the housing 224. The protective element 220 may be fixed to the housing 224 above the recessed portion 248a by a shoulder portion 250 of the housing 224. The microphone unit 208 also includes a mount 252 by which the microphone unit 208 may be mounted to or attached to a vehicle.

The first and second cavities 240a, 246a are indicated with dotted lines in FIG. 3B. The first cavity 240a may have a smaller volume than the second cavity 246a. In use, two Helmholtz resonators may be formed respectively by the cavities 240a, 246a. A Helmholtz resonator may be modeled as a mass-spring system, in which air inside the cavity plays the role of the spring and air passing through an opening of the cavity plays the role of the mass. A first Helmholtz resonator may be formed by the first cavity 240a and the vent 242a, where air passing through the vent 242a may act as the mass of the mass-spring system and the compressed air in the cavity 240a may act as the spring in the mass-spring system. A second Helmholtz resonator may be formed by the second cavity 246a and the perforations 226 in the protective element 220, where air passing through the perforations 226 may act as the mass of the mass-spring system and the compressed air in the cavity 246a may act as the spring in the mass-spring system. Although the above description considers the portion 232a, the elements may be the same for the portion 232b.

Helmholtz resonators may have a resonance at a resonance frequency, just as a mass-spring system may have a resonance at a resonance frequency. At the resonance frequency, an increased amplitude may be observed. Such resonances may be observed in the microphone unit 208, and may for example be excited by a precipitation event such as a raindrop striking the protective element 220.

Returning to FIG. 1, the computing system 112 may be configured to perform a method or process to determine a characteristic of weather in an environment of the vehicle 102. The computing system 112 may be configured to, as part of the process, receive an audio signal 120 from the microphone(s) of the microphone unit 108 and perform processing on the audio signal 120. As part of the processing, the computing system 112 may perform feature determination 122 to determine one or more audio features 124 from the audio signal 120. The audio feature(s) may for example include a spectrogram representation of the audio signal 120 and/or any of the other type of audio feature described above.

The computing system 112 may be configured to process at least part of the determined audio feature(s) 124 using a neural network 126. For example, the neural network may be used to process part of a spectrogram corresponding to an interval of 1, 2, 5, 10, or 60 seconds, or any other suitable duration. In some examples, the neural network may process other input data, such as data indicative of the speed or velocity of the vehicle, alongside the audio feature(s) 124. As a result of processing the audio feature(s) 124, the neural network may output data indicative of an estimated characteristic 128 associated with the environment in which the vehicle is operating. The estimated characteristic may for example be a number of precipitation events within the interval, or an effective or absolute precipitation rate, or a wind speed, or a classification of a type of precipitation, or an estimate of road wetness. In some examples, a classification of the type of precipitation may be determined as well as another characteristic quantifying the precipitation, such as a rate of precipitation. In an example, the neural network may have separate classification and regression heads for determining the two separate characteristics. In another example, a first neural network may be used to classify the type of precipitation, and a second neural network may be used to quantify the precipitation. The second neural network may optionally take the classification result as an input. Alternatively, different second neural networks may be trained to quantify different types of precipitation, and may be selectable by the computing system 112 in dependence on the classification result.

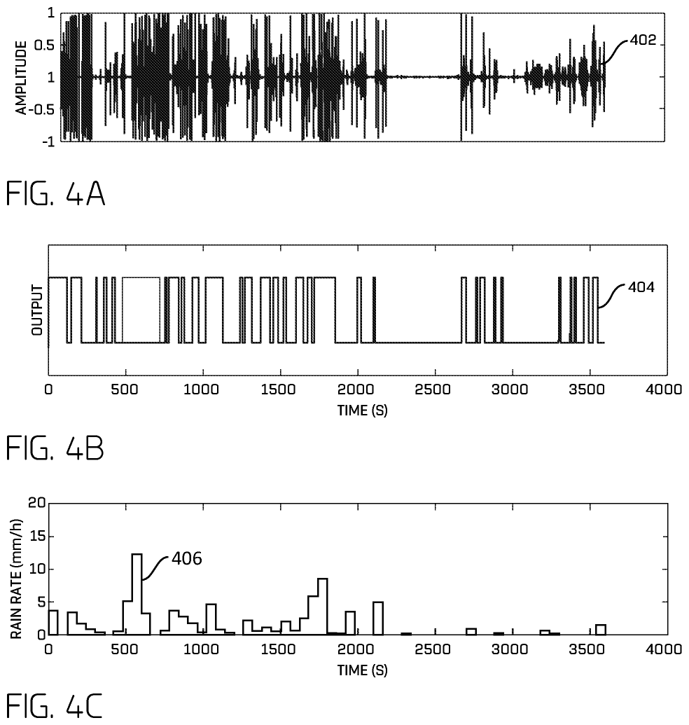

In an example, the estimated characteristic may be a binary classification of whether it is raining or not, or whether there is a rainfall rate exceeding a given threshold. FIG. 4A shows a waveform 402 representing an audio signal received from an exterior microphone of a vehicle over the course of an hour. It is observed that the waveform includes periods of relatively high amplitude and periods of relatively low amplitude. In this example, the audio signal is converted into a log-mel spectrogram with 64 mel bins by applying a STFT transform with frame size 10 ms. And a portion of the spectrogram corresponding to a 2 second interval is processed using a binary CNN classifier with two output classes “rain” and “no rain”. FIG. 4B shows the output 404 of the binary classifier for the audio signal. It is observed that the classifier accurately classifies periods of rain and no rain.

In another example, the estimated characteristic may be an absolute rain rate for example measured in millimeters of rain per hour. For this purpose, the neural network may be a CNN regressor trained to count the number of raindrops landing in the vicinity of the microphone in a given interval, which may then be converted to an absolute rain rate using the instantaneous velocity of the vehicle as described earlier in the present disclosure. In this case, the neural network may be trained using a training dataset comprising audio signals in which rain events are labeled, either by hand or using a machine-learned binary classifier. Alternatively, the neural network may be trained to directly estimate the rain rate. In this case, the velocity of the vehicle may optionally be provided as an additional input to the neural network. In this case, the neural network may be trained using a training dataset comprising audio signals labeled with ground truth rain rates, for example measured by alternative means such as physical rain collection. FIG. 4C shows the rain rate for the audio signal of FIG. 4A estimated using CNN regressor trained to count rain events.

In the present context it may be desirable to obtain an accurate estimate of the characteristic of the environment (for example, the rain rate) with low latency given the available computing resources, and to avoid excessive processing burden or memory footprint. This may be particularly important in the context of an autonomous vehicle where computing resources are used for a wide range of tasks when the vehicle is in operation, such as tasks relating to planning, perception, and prediction. A neural network architecture may therefore be chosen which achieves accurate estimation (e.g., high recall and low false positive rate) without significant latency or burden on computational resources. The neural network architecture used in FIG. 4B, referred to as CNN14, had ˜80 million parameters and was found to achieve a recall of over 90% and a false positive rate of less than 0.05%. It is expected that these results could be further improved by further training the neural network. However, the inventors have also discovered that a smaller neural network referred to as CNN10 with ˜6 million parameters was able to obtain similar accuracy with significantly reduced latency (for example, less than a second of latency).

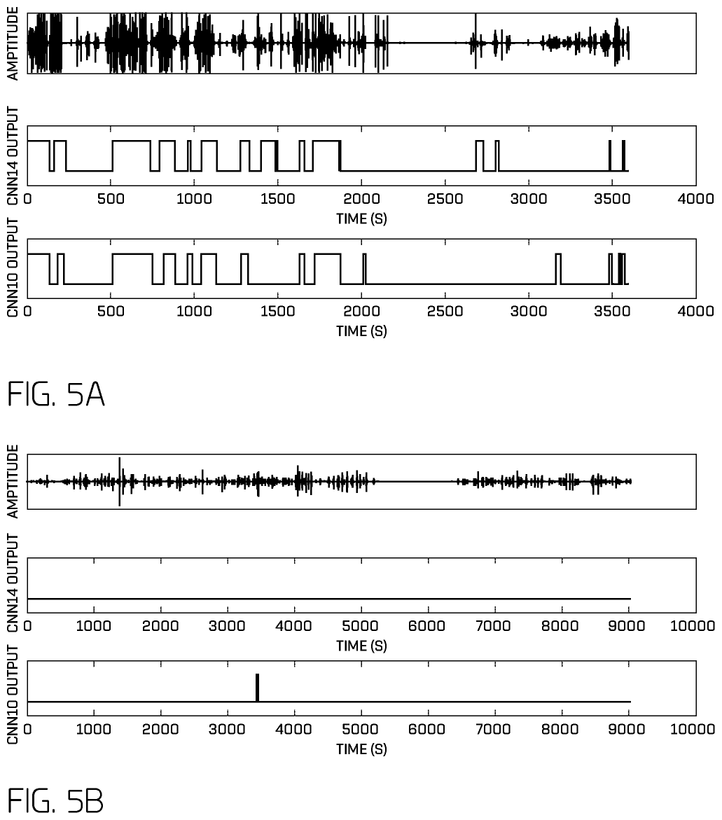

FIG. 5A shows a waveform 502 representing an audio signal received from an exterior microphone of a vehicle over the course of an hour in rainy conditions. The lower frames respectively show the outputs 504 and 506 of binary classifiers using the CNN14 and CNN10 architectures. It is observed that the CNN10 architecture achieves comparable recall despite having an order of magnitude fewer parameters and commensurately reduced latency. Similarly, FIG. 5B shows a waveform 508 representing an audio signal received from the exterior microphone of the vehicle over the course of an hour in dry conditions. The lower frames respectively show the outputs 510 and 512 of the binary classifiers using the CNN14 and CNN10 architectures. It is observed that CNN10 has a slightly higher false positive rate than CNN14. However, this may be improved by further training of the model and in any case an occasional false positive may be acceptable. The vehicle may for example be configured only to take actions, such as updating the ODD for the vehicle, after a threshold number of positive rain classifications is obtained within a given time frame.

The CNN10 architecture discussed above is arranged to process the spectrogram using a sequence of neural network layers. The layers in this example include four subsequences each comprising two 3×3 convolutional layers followed by batch normalization, a ReLU activation function, and a pooling operation. The number of convolutional kernels applied in each convolutional layer (and therefore the number of output channels of that layer) is 64 for the first subsequence (3×3@64), 128 for the second subsequence (3×3@128), 256 for the third subsequence (3×3@256), and 512 for the fourth subsequence (3×3@512). The pooling operations for the first three subsequences are 2×2 pooling, whereas the pooling operation for the fourth subsequence is global pooling which generates a respective single output value for each of the 512 channels. The four subsequences are followed by a neural network head comprising two fully connected layers, the first fully connected layer being followed by a ReLU activation function, and the second fully connected layer being followed by a Sigmoid activation function. In the example of binary classification, the second fully connected layer may have two outputs corresponding to the classification output and an associated confidence score.

It will be appreciated that the neural network architecture described above are exemplary and many other neural network architectures are possible, for example based on CNNs, R-CNNs (which may enable information to be propagated between intervals), and/or ViTs. Furthermore, the duration of the individual intervals input to the neural network may have a different duration, for example less than a second, one second, two seconds, five seconds, ten seconds, thirty seconds or sixty seconds, or any other suitable duration. The neural network may therefore generate estimates, optionally with associated confidence scores, of a characteristic for a sequence of intervals. The estimated characteristic may be averaged or otherwise combined (for example weighted according to the confidence score or combined using Bayesian statistics) to determine an estimate for the characteristic over a longer period of time, for example over a minute, two minutes, or any other suitable timeframe. In some examples, the characteristic may be estimated for contiguous intervals of the audio signal. In other examples, the intervals may be sampled, for example on a regular grid, which may reduce the latency and demands on computational resources. For example, the intervals may be sampled every five seconds, every ten seconds, or every twenty seconds, and the resulting estimates combined to determine an estimate over a longer period such as a minute or two minutes.

The computing system 112 may perform an ODD check 130 using the estimated characteristic 128 to determine whether the environment of the vehicle falls outside of an approved ODD for the vehicle. The ODD check 130 may additionally use other factors such as physical infrastructure, operational constraints, detected objects, and other environmental factors such as light level. In the event of the computer system 112 determining that the environment falls outside of the approved ODD, the computing system 112 may perform parameter modification 132 in which a parameter of the vehicle is modified or adjusted to account for the environment falling outside of the approved ODD. For example, the vehicle 102 may be an autonomous vehicle and a mode of operation may be changed based on the environment falling outside of the approved ODD. Alternatively, or additionally, the computing system 112 may perform one or more other actions, such as sending a message to a remote computing system including the characteristic data 128, and/or activating or otherwise controlling one or more windshield wipers and/or sensor cleaners. The ODD check 130 may be performed frequently, for example every second or every few seconds, enabling the vehicle to operate correctly even in changeable environmental conditions.

In the scenario 100, the vehicle 102 is driving from a first region 140 in which no rain is falling to a second region 142 in which rain 144 is falling. In the first region 140, a first portion of the audio signal 120 picked up by the microphone(s) of the microphone unit 108 may be unaffected by rainfall. Accordingly, the computing system 112 may process the first portion of the audio signal 120 as described above and determine that there is no rainfall on or in the vicinity of the vehicle 102, or that any such rainfall is below a threshold level. In the second region 142, rain 144 may begin to fall on the end 110 of the vehicle 102 at which the microphone unit 108 is mounted. Raindrops forming the rain 144 may land on a protective element of the microphone unit 108 and/or on another surface in the vicinity of the microphone unit. The computing system 112 may process a second portion of the audio signal 120 and determine that there is rainfall, and optionally quantify the rainfall either in terms of an effective or absolute rainfall characteristic. Alternatively, or additionally, the computing system 112 may estimate a degree of wetness of the road based on the audio signal 120.

In further examples, a plurality of microphone units may be mounted on different parts of the vehicle 102, such as at both ends of the vehicle 102, on top of the vehicle 102, and/or on both sides of the vehicle. The different microphone units, and in particular the protective elements of the different microphone units, may face in different directions depending on which parts of the vehicle they are mounted on. Each of the microphone units may be used to capture audio signals and the captured audio signals may be analyzed to estimate a characteristic of the environment. In such cases, additional characteristics of rainfall, such as effective rain direction and/or effective horizontal rain velocity, may be determined based at least in part on differences between the outputs corresponding to the different microphone units. In such cases, an absolute rain direction or absolute horizontal rain velocity may be inferred by further providing the velocity of the vehicle, for example by subtracting a vector representing the velocity of the vehicle from a vector representing the effective horizontal velocity of the rainfall.

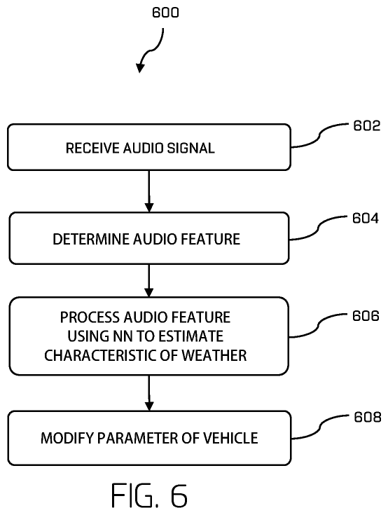

Based on the above, a generalized method may be defined, an example of which is shown by FIG. 6. The method 600 of FIG. 6 includes, at 602, receiving an audio signal from an audio sensor of a vehicle. The audio sensor may include a microphone in fluid communication with the environment exterior to the vehicle, and/or an accelerometer attached to a panel or surface of the vehicle.

The method 600 may include, at 604, determining an audio feature from the received audio signal. The audio feature may include a spectrogram of the received audio signal, which may be generated for example by applying a STFT to the audio signal. The spectrogram may be a log-mel spectrogram or a linear spectrogram or any other suitable representation of the variation of Fourier components of the audio signal over a duration of the audio signal. Other feature extraction techniques may be used to determine other audio features.

The method may include, at 606, processing the audio feature, using a neural network, to estimate a characteristic of weather in an environment of the vehicle. The characteristic of weather may for example be a characteristic of rainfall or other precipitation, or a characteristic of wind, or a characteristic of the environment that may be caused by weather, such as road wetness. The estimated characteristic may be based directly on the output of the neural network, for example where the neural network has been trained using ground truth values of the characteristic, or there may be intermediate steps to determine the characteristic, for example where the neural network has been trained to determine an intermediate variable such as number of precipitation events. The neural network may optionally be configured to estimate multiple characteristics in a single pass. The neural network may use other input data such as data indicative of the instantaneous velocity of the vehicle, or other environmental factors that may affect the audio signal, such as the presence of buildings or other vehicles or objects.

The method 600 may include modifying, at 608, a parameter of the vehicle based at least in part on the characteristic estimated at 606. For example, the characteristic may be used to determine that the environment of the vehicle falls outside of an approved ODD, and the parameter may be modified in the event of such a determination.

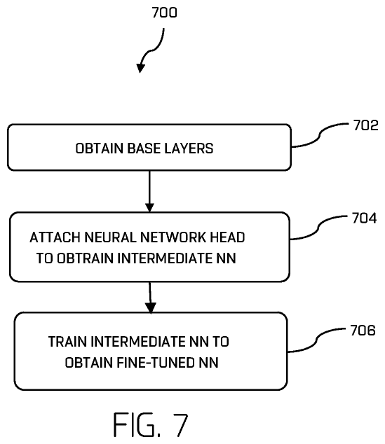

The neural networks described above may be trained to estimate a characteristic of an environment, for example using supervised learning using labeled training data. The process of labeling data may be challenging and/or resource intensive, and it may therefore be undesirable to train a neural network from scratch. A more efficient method of obtaining a trained neural network may be to use transfer learning based on a pre-trained neural network, as described below with reference to FIG. 7.

The method 700 of FIG. 7 begins with obtaining, at 702, a set of base layers of a pre-trained neural network. The pre-trained neural network may be a pre-trained audio neural network (PANN) trained on a large-scale audio dataset such as the AudioSet dataset. The PANN may not have been trained to detect rain events, but may have been trained to detect and/or classify other types of audio events. The base layers may include the initial layers of the PANN, including the input layer and a sequence of hidden layers such as convolutional layers. The base layers may exclude a network head comprising a final set of layers of the PANN, including fully-connected layers and/or other layers used to generate an output. The base layers may be primarily responsible for feature extraction, and may therefore be utilized, either unmodified or with additional training, for feature extraction in the context of a different task. Data generated at the last base layer may be an embedding of features extracted from an audio signal.

The method 700 may include adding, at 704, a network head to the set of base layers to obtain an intermediate neural network. The network head include a further set of neural network layers configured to receive data from the last base layer and to generate an output indicative of the characteristic to be estimated, for example a classification result or a regression result, and optionally one or more confidence values. The network head may for example include one or more fully-connected layers. The parameters (e.g., weights, biases) of the layers of the network head may be initialized in any suitable manner, for example randomly. The intermediate neural network may therefore consist of trained base layers and an untrained network head.

The method 700 may include training, at 706, the intermediate neural network using data comprising training audio features corresponding to training audio signals with respective labels indicating respective characteristics associated with the training audio signals, thereby to obtain a fine-tuned neural network. The training may use supervised learning in which parameters of the neural network are updated using gradient descent or a suitable variant of gradient descent with respect to a loss function. The loss function may for example be any suitable loss function for comparing labeled values of the characteristic with values estimated by the neural network. The training may optionally include an initial phase in which the parameter values of the base layers are frozen and only the parameter values of the network head are updated. The network head may have significantly fewer parameters than the set of base layers, so freezing the parameter values of the base layer may result in significantly more efficient training of the network head, both in terms of computational resources and volume of training data. After the initial training phase has taken place (for example after a predetermined number of training iterations, or when all of the available training data has been processed), the training may include an additional phase in which the parameter values of the base layers are unfrozen, and all of the network parameters are trained jointly. In this way, the base layers may be fine-tuned for efficacy with the new task, namely estimating a characteristic of an environment exterior to a vehicle. Compared with training the neural network from scratch, this process of transfer learning may significantly reduce the volume of labeled data required to train the neural network, whilst also increasing the rate of performance improvement during training, and increasing the asymptotic performance of the neural network.

Although the description in relation to FIGS. 1-7 is provided relative to an audio signal or signals from one microphone of a microphone unit, in other examples audio signals from two or more audio sensors may be used in combination. For example, using a microphone unit having a plurality of microphones, such as the microphone unit 208 of FIGS. 2A to 3B that includes two microphones 230a, 230b, audio signals from different microphones may be used and processed to estimate a characteristic of weather in the environment. In this regard, characteristics estimated from different audio sensors may be averaged or otherwise combined or fused to provide a more accurate estimation. Estimates or data determined during any or all of the above methods may be averaged or otherwise combined or fused to determine a more accurate estimation of one or more characteristics of the environment. For example, fusing results obtained from a microphone with results obtained from an accelerometer may result in improved and more robust performance.

Furthermore, variations in a characteristic such as the numbers of precipitation events as estimated using multiple audio sensors, optionally combined with the velocity of the vehicle, may be used to determine absolute precipitation characteristics. If estimations of a given characteristic differ significantly between different audio sensors, then it may be inferred that such estimations do not result from rainfall but from a different process such as splashing or otherwise blocking the protective mesh a microphone unit. In this case, further operations may be carried out, for example generating an alert or performing an action to clean one or more microphone units.

In some examples, a computing system may, based on the estimated characteristic or in parallel with estimating the characteristic, determine a confidence score for the estimated characteristic. The confidence score may be dependent on an amount of data on which the characteristic is based, a speed of the vehicle during determination of the characteristic, a level of background noise, or one or more other factors, or may be generated as an output of the neural network. Furthermore, to estimate a characteristic and/or to determine a confidence score in the estimated characteristic, the computing system may combine information from different analysis techniques or from different types of sensor, such as different types of audio sensor as discussed above. The resulting characteristic may be determined by averaging or by any other suitable multi-input operation, and the associated confidence score may be determined based on a variance between different estimates of the characteristic. The resulting characteristic, and optionally the associated confidence score, may be determined using Bayesian statistics. In some examples, different estimates of the characteristic may be fused using a machine-learned model, such as a neural network model trained by supervised learning to estimate the characteristic based on multiple input values.

FIG. 8 illustrates a block diagram of an example system 800 that implements the techniques discussed herein. FIG. 8 may represent the vehicle 102 and computing device 112 of FIG. 1. In some instances, the example system 800 may include a vehicle 802, which may represent the vehicle 102 in FIG. 1. In some instances, the vehicle 802 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 802 may be a fully or partially autonomous vehicle having any other level or classification. Moreover, in some instances, the techniques described herein may be usable by non-autonomous vehicles as well.

The vehicle 802 may include a vehicle computing device(s) 804, sensor(s) 806, emitter(s) 808, network interface(s) 810, and/or drive system(s) 812. Sensor(s) 806 may represent sensor(s) 106. The system 800 may additionally or alternatively comprise computing device(s) 832.

In some instances, the sensor(s) 806 may include lidar sensors, radar sensors, ultrasonic transducers, sonar sensors, location sensors (e.g., global positioning system (GPS), compass, etc.), inertial sensors (e.g., inertial measurement units (IMUs), accelerometers, magnetometers, gyroscopes, etc.), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors, etc.), etc. The sensor(s) 806 may include multiple instances of each of these or other types of sensors. For instance, the radar sensors may include individual radar sensors located at the corners, front, back, sides, and/or top of the vehicle 802. As another example, the cameras may include multiple cameras disposed at various locations about the exterior and/or interior of the vehicle 802. The sensor(s) 806 may provide input to the vehicle computing device(s) 804 and/or to computing device(s) 832.

The vehicle 802 may also include emitter(s) 808 for emitting light and/or sound, as described above. The emitter(s) 808 may include interior audio and visual emitter(s) to communicate with passengers of the vehicle 802. Interior emitter(s) may include speakers, lights, signs, display screens, touch screens, haptic emitter(s) (e.g., vibration and/or force feedback), mechanical actuators (e.g., seatbelt tensioners, seat positioners, headrest positioners, etc.), and the like. The emitter(s) 808 may also include exterior emitter(s). Exterior emitter(s) may include lights to signal a direction of travel or other indicator of vehicle action (e.g., indicator lights, signs, light arrays, etc.), and one or more audio emitter(s) (e.g., speakers, speaker arrays, horns, etc.) to audibly communicate with pedestrians or other nearby vehicles, one or more of which comprising acoustic beam steering technology.

The vehicle 802 may also include network interface(s) 810 that enable communication between the vehicle 802 and one or more other local or remote computing device(s). The network interface(s) 810 may facilitate communication with other local computing device(s) on the vehicle 802 and/or the drive component(s) 812. The network interface(s) 810 may additionally or alternatively allow the vehicle to communicate with other nearby computing device(s) (e.g., other nearby vehicles, traffic signals, etc.). The network interface(s) 810 may additionally or alternatively enable the vehicle 802 to communicate with computing device(s) 832 over a network 828. In some examples, computing device(s) 832 may comprise one or more nodes of a distributed computing system (e.g., a cloud computing architecture).

The vehicle 802 may include one or more drive components 812. In some instances, the vehicle 802 may have a single drive component 812. In some instances, the drive component(s) 812 may include one or more sensors to detect conditions of the drive component(s) 812 and/or the surroundings of the vehicle 802. By way of example and not limitation, the sensor(s) of the drive component(s) 812 may include one or more wheel encoders (e.g., rotary encoders) to sense rotation of the wheels of the drive components, inertial sensors (e.g., inertial measurement units, accelerometers, gyroscopes, magnetometers, etc.) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive component(s) 812. In some cases, the sensor(s) on the drive component(s) 812 may overlap or supplement corresponding systems of the vehicle 802 (e.g., sensor(s) 806).

The drive component(s) 812 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 812 may include a drive component controller which may receive and pre-process data from the sensor(s) and to control operation of the various vehicle systems. In some instances, the drive component controller may include one or more processors and memory communicatively coupled with the one or more processors. The memory may store one or more components to perform various functionalities of the drive component(s) 812. Furthermore, the drive component(s) 812 may also include one or more communication connection(s) that enable communication by the respective drive component with one or more other local or remote computing device(s).

The vehicle computing device(s) 804 may include processor(s) 814 and memory 816 communicatively coupled with the one or more processors 814. Computing device(s) 832 may also include processor(s) 834, and/or memory 836. The processor(s) 814 and/or 834 may be any suitable processor capable of executing instructions to process data and perform operations as described herein. By way of example and not limitation, the processor(s) 814 and/or 834 may comprise one or more central processing units (CPUs), graphics processing units (GPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 816 and/or 836 may be examples of non-transitory computer-readable media. The memory 816 and/or 836 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), non-volatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 816 and/or memory 836 may store a perception component 818, localization component 820, planning component 822, map(s) 824, driving log data 826, prediction component 828, and/or system controller(s) 830—zero or more portions of any of which may be hardware, such as GPU(s), CPU(s), and/or other processing units.

The perception component 818 may detect object(s) in in an environment surrounding the vehicle 802 (e.g., identify that an object exists), classify the object(s) (e.g., determine an object type associated with a detected object), segment sensor data and/or other representations of the environment (e.g., identify a portion of the sensor data and/or representation of the environment as being associated with a detected object and/or an object type), determine characteristics associated with an object (e.g., a track identifying current, predicted, and/or previous position, heading, velocity, and/or acceleration associated with an object), and/or the like. Data determined by the perception component 818 is referred to as perception data. The perception component 818 may be configured to associate a bounding region (or other indication) with an identified object. The perception component 818 may be configured to associate a confidence score associated with a classification of the identified object with an identified object. In some examples, objects, when rendered via a display, can be colored based on their perceived class. The object classifications determined by the perception component 818 may distinguish between different object types such as, for example, a passenger vehicle, a pedestrian, a bicyclist, motorist, a delivery truck, a semi-truck, traffic signage, and/or the like.

In at least one example, the localization component 820 may include hardware and/or software to receive data from the sensor(s) 806 to determine a position, velocity, and/or orientation of the vehicle 802 (e.g., one or more of an x-, y-, z-position, roll, pitch, or yaw). For example, the localization component 820 may include and/or request/receive map(s) 824 of an environment and can continuously determine a location, velocity, and/or orientation of the autonomous vehicle 802 within the map(s) 824. In some instances, the localization component 820 may utilize SLAM (simultaneous localization and mapping), CLAMS (calibration, localization and mapping, simultaneously), relative SLAM, bundle adjustment, non-linear least squares optimization, and/or the like to receive image data, lidar data, radar data, IMU data, GPS data, wheel encoder data, and the like to accurately determine a location, pose, and/or velocity of the autonomous vehicle. In some instances, the localization component 820 may provide data to various components of the vehicle 802 to determine an initial position of an autonomous vehicle for generating a trajectory and/or for generating map data, as discussed herein. In some examples, localization component 820 may provide, to the perception component 818, a location and/or orientation of the vehicle 802 relative to the environment and/or sensor data associated therewith.

The planning component 822 may receive a location and/or orientation of the vehicle 802 from the localization component 820 and/or perception data from the perception component 818 and may determine instructions for controlling operation of the vehicle 802 based at least in part on any of this data. In some examples, determining the instructions may comprise determining the instructions based at least in part on a format associated with a system with which the instructions are- 27 -opfield- 27 -ed (e.g., first instructions for controlling motion of the autonomous vehicle may be formatted in a first format of messages and/or signals (e.g., analog, digital, pneumatic, kinematic) that the system controller(s) 830 and/or drive component(s) 812 may parse/cause to be carried out, second instructions for the emitter(s) 808 may be formatted according to a second format associated therewith).

The driving log data 826 may comprise sensor data, perception data, and/or scenario labels collected/determined by the vehicle 802 (e.g., by the perception component 818), as well as any other message generated and or sent by the vehicle 802 during operation including, but not limited to, control messages, error messages, etc. In some examples, the vehicle 802 may transmit the driving log data 826 to the computing device(s) 832.

The prediction component 828 may generate one or more probability maps representing prediction probabilities of possible locations of one or more objects in an environment. For example, the prediction component 828 may generate one or more probability maps for vehicles, pedestrians, animals, and the like within a threshold distance from the vehicle 802. In some examples, the prediction component 828 may measure a track of an object and generate a discretized prediction probability map, a heat map, a probability distribution, a discretized probability distribution, and/or a trajectory for the object based on observed and predicted behavior. In some examples, the one or more probability maps may represent an intent of the one or more objects in the environment. In some examples, the planner component 822 may be communicatively coupled to the prediction component 828 to generate predicted trajectories of objects in an environment. For example, the prediction component 828 may generate one or more predicted trajectories for objects within a threshold distance from the vehicle 802. In some examples, the prediction component 828 may measure a trace of an object and generate a trajectory for the object based on observed and predicted behavior. Although prediction component 828 is shown on a vehicle 802 in this example, the prediction component 828 may also be provided elsewhere, such as in a remote computing device. In some examples, a prediction component may be provided at both a vehicle and a remote computing device. These components may be configured to operate according to the same or a similar algorithm.

The memory 816 and/or 836 may additionally or alternatively store a mapping system, a planning system, a ride management system, etc. Although perception component 818 and/or planning component 822 are illustrated as being stored in memory 816, perception component 818 and/or planning component 822 may include processor-executable instructions, machine-learned model(s) (e.g., a neural network), and/or hardware.

As described herein, the localization component 820, the perception component 818, the planning component 822, and/or other components of the system 800 may comprise one or more ML models. For example, the localization component 820, the perception component 818, and/or the planning component 822 may each comprise different ML model pipelines. In some examples, an ML model may comprise a neural network. An exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine-learning, which can refer to a broad class of such algorithms in which an output is generated based on learned parameters.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAD)), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, -29 -opfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, and the like. In some examples, the ML model discussed herein may comprise PointPillars, SECOND, top-down feature layers (e.g., see U.S. patent application Ser. No. 15/963,833, which is incorporated in its entirety herein), and/or VoxelNet. Architecture latency optimizations may include MobilenetV2, Shufflenet, Channelnet, Peleenet, and/or the like. The ML model may comprise a residual block such as Pixor, in some examples.

Memory 820 may additionally or alternatively store one or more system controller(s) 830, which may be configured to control steering, propulsion, braking, safety, emitters, communication, and other systems of the vehicle 802. These system controller(s) 830 may communicate with and/or control corresponding systems of the drive component(s) 812 and/or other components of the vehicle 802.

It should be noted that while FIG. 8 is illustrated as a distributed system, in alternative examples, components of the vehicle 802 may be associated with the computing device(s) 832 and/or components of the computing device(s) 832 may be associated with the vehicle 802. That is, the vehicle 802 may perform one or more of the functions associated with the computing device(s) 832, and vice versa.

### Example Clauses

A. A vehicle comprising: a microphone; one or more processors; and one or more non-transitory computer-readable media storing instructions which, when executed by the one or more processors, cause the one or more processors to perform operations comprising: receiving an audio signal from the microphone; applying a short-time Fourier transform (STFT) to the received audio signal to generate a spectrogram of the received audio signal; processing, using a convolutional neural network (CNN), at least part of the generated spectrogram to determine a number of raindrops striking the vehicle in a vicinity of the microphone within an interval; estimating, based at least in part on the determined number of raindrops, a characteristic associated with an environment of the vehicle; determining, based at least in part on the estimated characteristic, that the environment is outside of an approved operational design domain (ODD) for the vehicle; and modifying, based at least in part on the determining that the environment is outside of the approved ODD, a parameter of the vehicle.

B. The vehicle of clause A, wherein: the operations comprise obtaining data indicative of a speed of the vehicle within the interval; and the estimating of the characteristic comprises estimating, using the data indicative of the speed of the vehicle and the determined number of raindrops striking the vehicle in within the interval, the absolute rain rate.

C. The vehicle of clause A or B, wherein: the microphone is a first microphone disposed at a first position on the vehicle; the audio signal is a first audio signal; the operations comprise receiving a second audio signal from a second microphone disposed at a second position on the vehicle; and the estimating of the characteristic is further based on the second audio signal.

D. The vehicle of claim 1, wherein the operations comprise suspending full autonomous driving operations based at least in part on the modifying of the parameter.

E. A method comprising: receiving an audio signal from an audio sensor of a vehicle; determining an audio feature from the received audio signal; processing, using a neural network, the audio feature to estimate a characteristic of weather in an environment of the vehicle; and modifying, based at least in part on the estimated characteristic, a parameter of the vehicle.

F. The method of clause E, comprising obtaining data indicative of a speed of the vehicle, wherein the processing comprises at least one of: processing an output of the neural network together with the data indicative of the speed of the vehicle, or processing, using the neural network, the data indicative of the speed of the vehicle together with the audio feature.

G. The method of clause E or F, comprising obtaining data indicative of an environmental condition, wherein: the processing comprises processing, using the neural network, the data indicative of the environmental condition together with the audio feature; and the environmental condition comprises any of wind velocity, humidity, air temperature, or air pressure.

H. The method of any one of clauses E to G, wherein: the transducer is a first transducer disposed at a first position on the vehicle; the audio signal is a first audio signal; the method comprises receiving a second audio signal from a second transducer disposed at a second position on the vehicle; and the estimating of the characteristic is further based on the second audio signal.

I. The method of any one of clauses E to H, comprising controlling the vehicle according to the modified parameter of the vehicle.

J. The method of any one of clauses E to I, comprising determining, based at least in part on the estimated characteristic, that the environment is outside of an approved ODD for the vehicle; and suspending full autonomous driving operations based at least in part on the modifying of the parameter.

K. The method of any one of clauses E to J, wherein the neural network is a fine-tuned neural network, the method comprising: obtaining a set of base layers of a pre-trained neural network, wherein the pre-trained neural network has been trained to detect audio events; adding a network head to the set of base layers to obtain an intermediate neural network; and training the intermediate neural network using data comprising training audio features with respective labels indicating respective characteristics associated with the training audio features, thereby to obtain the fine-tuned neural network.

L. The method of any one of clauses E to K, wherein the characteristic is indicative of a rate of precipitation events.

M. The method of any one of clauses of E to L, wherein the characteristic comprises a classification of a type of precipitation in the environment of the vehicle.

N. The method of any one of clauses E to M, wherein the audio sensor is a microphone.

O. One or more non-transitory computer-readable media storing instructions executable by one or more processors, wherein the instructions, when executed, cause the one or more processors to perform operations comprising: receiving an audio signal from an audio sensor of a vehicle; determining an audio feature from the received audio signal; processing, using a neural network, the audio feature to estimate a characteristic of weather in an environment of the vehicle; and modifying, based at least in part on the estimated characteristic, a parameter of the vehicle.

P. The one or more non-transitory computer-readable media of clause O, wherein: the operations comprise obtaining data indicative of a speed of the vehicle; and the processing comprises at least one of: processing an output of the neural network together with the data indicative of the speed of the vehicle, or processing, using the neural network, the data indicative of the speed of the vehicle together with the audio feature.

Q. The one or more non-transitory computer-readable media of clause O or P, wherein: the transducer is a first transducer disposed at a first position on the vehicle; the audio signal is a first audio signal; the operations comprise receiving a second audio signal from a second transducer disposed at a second position on the vehicle; and the estimating of the characteristic is further based on the second audio signal.

R. The one or more non-transitory computer-readable media of any one of clauses O to Q, wherein the operations comprise: determining, based at least in part on the estimated characteristic, that the environment is outside of an approved ODD for the vehicle; and suspending full autonomous driving operations based at least in part on the modifying of the parameter.

S. The one or more non-transitory computer-readable media of any one of clauses O to R, wherein the characteristic comprises a classification of precipitation in the environment of the vehicle.

T. The one or more non-transitory computer-readable media of any one of clauses O to S, wherein the audio sensor is a microphone.

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations, and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into subcomputations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow charts, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art. Note that the term substantially may indicate a range. For example, substantially simultaneously may indicate that two activities occur within a time range of each other, substantially a same dimension may indicate that two elements have dimensions within a range of each other, and/or the like.

Many variations and modifications may be made to the above-described examples, the elements of which are to be understood as being among other acceptable examples. All such modifications and variations are intended to be included herein within the scope of this disclosure and protected by the following claims.

What is claimed is:

1. A vehicle comprising:
a microphone;
one or more processors; and
one or more non-transitory computer-readable media storing instructions which, when executed by the one or more processors, cause the one or more processors to perform operations comprising:
receiving an audio signal from the microphone;
applying a short-time Fourier transform (STFT) to the received audio signal to generate a spectrogram of the received audio signal;
processing, using a convolutional neural network (CNN), at least part of the generated spectrogram to determine a number of raindrops striking the vehicle in a vicinity of the microphone within an interval;
estimating, based at least in part on the determined number of raindrops, a characteristic associated with an environment of the vehicle;
determining, based at least in part on the estimated characteristic, that the environment is outside of an approved operational design domain (ODD) for the vehicle; and
modifying, based at least in part on the determining that the environment is outside of the approved ODD, a parameter of the vehicle.

2. The vehicle of claim 1, wherein:
the operations comprise obtaining data indicative of a speed of the vehicle within the interval; and
the estimating of the characteristic comprises estimating, using the data indicative of the speed of the vehicle and the determined number of raindrops striking the vehicle in within the interval, the absolute rain rate.

3. The vehicle of claim 1, wherein:
the microphone is a first microphone disposed at a first position on the vehicle;
the audio signal is a first audio signal;
the operations comprise receiving a second audio signal from a second microphone disposed at a second position on the vehicle; and
the estimating of the characteristic is further based on the second audio signal.

4. The vehicle of claim 1, wherein the operations comprise suspending full autonomous driving operations based at least in part on the modifying of the parameter.

5. A method comprising:
receiving an audio signal from an audio sensor of a vehicle;
determining an audio feature from the received audio signal;
processing, using a neural network, the audio feature to estimate a characteristic of weather in an environment of the vehicle; and
modifying, based at least in part on the estimated characteristic, a parameter of the vehicle.

6. The method of claim 5, comprising obtaining data indicative of a speed of the vehicle,
wherein the processing comprises at least one of:
processing an output of the neural network together with the data indicative of the speed of the vehicle, or
processing, using the neural network, the data indicative of the speed of the vehicle together with the audio feature.

7. The method of claim 5, comprising obtaining data indicative of an environmental condition, wherein:
the processing comprises processing, using the neural network, the data indicative of the environmental condition together with the audio feature; and
the environmental condition comprises any of wind velocity, humidity, air temperature, or air pressure.

8. The method of claim 5, wherein:
the transducer is a first transducer disposed at a first position on the vehicle;
the audio signal is a first audio signal;
the method comprises receiving a second audio signal from a second transducer disposed at a second position on the vehicle; and
the estimating of the characteristic is further based on the second audio signal.

9. The method of claim 5, comprising controlling the vehicle according to the modified parameter of the vehicle.

10. The method of claim 5, comprising
determining, based at least in part on the estimated characteristic, that the environment is outside of an approved ODD for the vehicle; and
suspending full autonomous driving operations based at least in part on the modifying of the parameter.

11. The method of claim 5, wherein the neural network is a fine-tuned neural network, the method comprising:
obtaining a set of base layers of a pre-trained neural network, wherein the pre-trained neural network has been trained to detect audio events;
adding a network head to the set of base layers to obtain an intermediate neural network; and
training the intermediate neural network using data comprising training audio features with respective labels indicating respective characteristics associated with the training audio features, thereby to obtain the fine-tuned neural network.

12. The method of claim 5, wherein the characteristic is indicative of a rate of precipitation events.

13. The method of claim 5, wherein the characteristic comprises a classification of a type of precipitation in the environment of the vehicle.

14. The method of claim 5, wherein the audio sensor is a microphone.

15. One or more non-transitory computer-readable media storing instructions executable by one or more processors, wherein the instructions, when executed, cause the one or more processors to perform operations comprising:
receiving an audio signal from an audio sensor of a vehicle;
determining an audio feature from the received audio signal;
processing, using a neural network, the audio feature to estimate a characteristic of weather in an environment of the vehicle; and
modifying, based at least in part on the estimated characteristic, a parameter of the vehicle.

16. The one or more non-transitory computer-readable media of claim 15, wherein:
the operations comprise obtaining data indicative of a speed of the vehicle; and
the processing comprises at least one of:
processing an output of the neural network together with the data indicative of the speed of the vehicle, or
processing, using the neural network, the data indicative of the speed of the vehicle together with the audio feature.

17. The one or more non-transitory computer-readable media of claim 15, wherein:
the transducer is a first transducer disposed at a first position on the vehicle;
the audio signal is a first audio signal;
the operations comprise receiving a second audio signal from a second transducer disposed at a second position on the vehicle; and
the estimating of the characteristic is further based on the second audio signal.

18. The one or more non-transitory computer-readable media of claim 15, wherein the operations comprise:
determining, based at least in part on the estimated characteristic, that the environment is outside of an approved ODD for the vehicle; and
suspending full autonomous driving operations based at least in part on the modifying of the parameter.

19. The one or more non-transitory computer-readable media of claim 15, wherein the characteristic comprises a classification of precipitation in the environment of the vehicle.

20. The one or more non-transitory computer-readable media of claim 15, wherein the audio sensor is a microphone.
